(19) United States
(12) Patent Application Publication
(10) Pub. No.: US 2025/0244800 A1
(43) Pub. Date: Jul. 31, 2025

(54) CONNECTION DEVICE AND ELECTRONIC DEVICE

(71) Applicant: Lenovo (Beijing) Limited, Beijing (CN)

(72) Inventor: Xiaosong XIA, Beijing (CN)

(21) Appl. No.: 19/015,353

(22) Filed: Jan. 9, 2025

(30) Foreign Application Priority Data
Jan. 31, 2024 (CN) 202410141081.0

(51) Int. Cl. G06F 1/16

(52) U.S. Cl. CPC G06F 1/1681; G06F 1/1616

(57) ABSTRACT

A connection device includes a shaft, a first motion assembly connected to the shaft, and a second motion assembly connected to the shaft. When the connection device is in a first angle range, the second motion assembly is in a first state in which a position of the second motion assembly relative to the shaft remains unchanged, and the first motion assembly is in a second state. When the connection device is in a second angle range, the first motion assembly is in the first state in which a position of the first motion assembly relative to the shaft remains unchanged, and the second motion assembly is in the second state.

### CROSS-REFERENCE TO RELATED APPLICATION

This application claims priority to Chinese Patent Application No. 202410141081.0, filed on Jan. 31, 2024, the entire content of which is incorporated herein by reference.

### TECHNICAL FIELD

The present disclosure generally relates to the field of electronic device technologies and, more particularly, to a connection device and an electronic device.

### BACKGROUND

A connection device is used to connect two parts that need to rotate relative to each other. For example, a screen part and a main unit part of a laptop computer are connected through a connection device to realize the opening and closing functions of the laptop computer. As laptop computers become thinner and lighter, it is impossible to open the laptop computer with one hand using conventional connection devices.

### SUMMARY

In accordance with the disclosure, there is provided a connection device including a shaft, a first motion assembly connected to the shaft, and a second motion assembly connected to the shaft. When the connection device is in a first angle range, the second motion assembly is in a first state in which a position of the second motion assembly relative to the shaft remains unchanged, and the first motion assembly is in a second state. When the connection device is in a second angle range, the first motion assembly is in the first state in which a position of the first motion assembly relative to the shaft remains unchanged, and the second motion assembly is in the second state.

Also in accordance with the disclosure, there is provided an electronic device including a first body, a second body, and a connection device including a shaft, a first motion assembly connected to the shaft and the first body, and a second motion assembly connected to the shaft and the second body. When the electronic device is in a first usage mode, the connection device is in a first angle range, the second motion assembly is in a first state in which a position of the second motion assembly relative to the shaft remains unchanged, and the first motion assembly is in a second state. When the electronic device is in a second usage mode, the connection device is in a second angle range, the first motion assembly is in the first state in which a position of the first motion assembly relative to the shaft remains unchanged, and the second motion assembly is in the second state.

### BRIEF DESCRIPTION OF THE DRAWINGS

To more clearly illustrate the technical solutions of the embodiments of the present disclosure, the drawings needed for use in the description of the embodiments will be briefly introduced below. The drawings described below are some embodiments of the present disclosure. For those ordinary in the art, other drawings can be obtained based on these drawings without any creative work.

FIG. 1 is a schematic diagram of an electronic device consistent with embodiments of the present disclosure.

FIG. 2 shows a side view of an electronic device consistent with embodiments of the present disclosure.

FIG. 3 is a schematic diagram of a connection device consistent with embodiments of the present disclosure.

FIG. 4 shows an exploded view of a connection device consistent with embodiments of the present disclosure.

FIG. 5 is a schematic diagram of the connection device with angle α in FIG. 2 equal to 0°, consistent with embodiments of the present disclosure.

FIG. 6 is a schematic diagram of the connection device with angle α in FIG. 2 equal to 0°, cut off at position A in FIG. 5, consistent with embodiments of the present disclosure.

FIG. 7 is a schematic diagram of the connection device with angle α in FIG. 2 equal to 0°, cut off at position B in FIG. 5, consistent with embodiments of the present disclosure.

FIG. 8 is a schematic diagram of the connection device with angle α in FIG. 2 equal to 110°, consistent with embodiments of the present disclosure.

FIG. 9 is a schematic diagram of the connection device, cut off at position A in FIG. 8, after being opened from the status shown in FIG. 5 to the status shown in FIG. 8, consistent with embodiments of the present disclosure.

FIG. 10 is a schematic diagram of the connection device, cut off at position B in FIG. 8, after being opened from the status shown in FIG. 5 to the status shown in FIG. 8, consistent with embodiments of the present disclosure.

FIG. 11 is a schematic diagram of the connection device, cut off at position A in FIG. 8, during the process of being opened from the status shown in FIG. 8 to the status shown in FIG. 13, consistent with embodiments of the present disclosure.

FIG. 12 is a schematic diagram of the connection device, cut off at position B in FIG. 8, during the process of being opened from the status shown in FIG. 8 to the status shown in FIG. 13, consistent with embodiments of the present disclosure.

FIG. 13 is a schematic diagram of the connection device with angle α in FIG. 2 equal to 180°, consistent with embodiments of the present disclosure.

FIG. 14 is a schematic diagram of the connection device with angle α in FIG. 2 equal to 180°, cut off at position A in FIG. 13, consistent with embodiments of the present disclosure.

FIG. 15 is a schematic diagram of the connection device with angle α in FIG. 2 equal to 180°, cut off at position B in FIG. 13, consistent with embodiments of the present disclosure.

FIG. 16 is a schematic diagram of the connection device, cut off at position A in FIG. 8, after being closed from the status shown in FIG. 13 to the status shown in FIG. 8, consistent with embodiments of the present disclosure.

FIG. 17 is a schematic diagram of the connection device, cut off at position B in FIG. 8, after being closed from the status shown in FIG. 13 to the status shown in FIG. 8, consistent with embodiments of the present disclosure.

FIG. 18 is a schematic diagram of the connection device, cut off at position A in FIG. 8, during the process of being closed from the status shown in FIG. 8 to the status shown in FIG. 5, consistent with embodiments of the present disclosure.

FIG. 19 is a schematic diagram of the connection device, cut off at position B in FIG. 8, during the process of being closed from the status shown in FIG. 8 to the status shown in FIG. 5, consistent with embodiments of the present disclosure.

FIG. 20 is a schematic diagram showing a torque of an electronic device consistent with embodiments of the present disclosure.

FIG. 21 is a schematic diagram of another connection device with angle α in FIG. 2 equal to 0°, consistent with embodiments of the present disclosure.

FIG. 22 is a top view of the connection device shown in FIG. 21.

FIG. 23 is a schematic diagram of another connection device with angle α in FIG. 2 equal to 110°, consistent with embodiments of the present disclosure.

FIG. 24 is a top view of the connection device shown in FIG. 23.

FIG. 25 is a schematic diagram of another connection device with angle α in FIG. 2 equal to 180°, consistent with embodiments of the present disclosure.

FIG. 26 is a top view of the connection device shown in FIG. 25.

1—First body; 2—Second body; 21—Foot pad; 3—Connection device; 31—First motion assembly; 32—Second motion assembly; 33—Switch assembly; 34—Elastic member; 35—Nut; 36—Shaft; 311—First slide slot; 312—First clamp slot; 321—Second connector; 322—Third sleeve member; 323—Fourth sleeve member; 3231—Second slide slot; 3232—Second clamp slot; 3233—Third stopper; 3234—Fourth stopper; 331—First protrusion; 332—Second protrusion; 333—Switch member; 361—First shaft member; 362—Second shaft member.

### DETAILED DESCRIPTION OF THE EMBODIMENTS

The present disclosure provides a connection device, which is conducive to reducing the design difficulty of the one-handed opening function of a laptop computer.

To make the purpose, technical solution, and advantages of the embodiments of the present disclosure clearer, the technical solution in the embodiments of the present disclosure will be described below in conjunction with the drawings in the embodiments of the present disclosure. The described embodiments are some of the embodiments of the present application, not all of the embodiments. Based on the embodiments in the present disclosure, all other embodiments obtained by those skilled in the art without creative work are within the scope of the present disclosure.

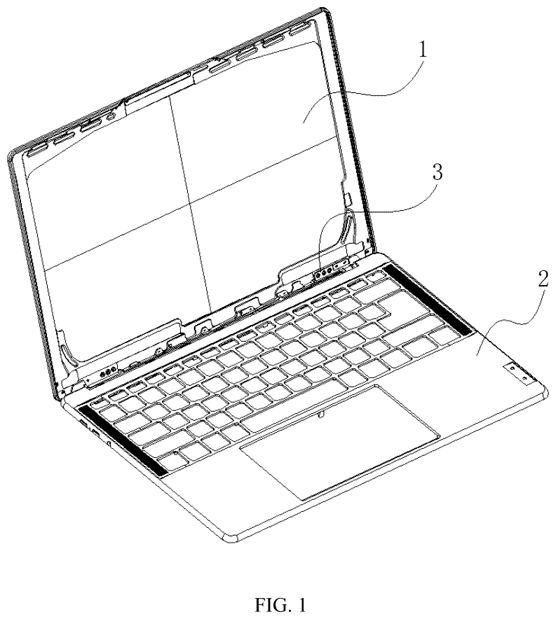

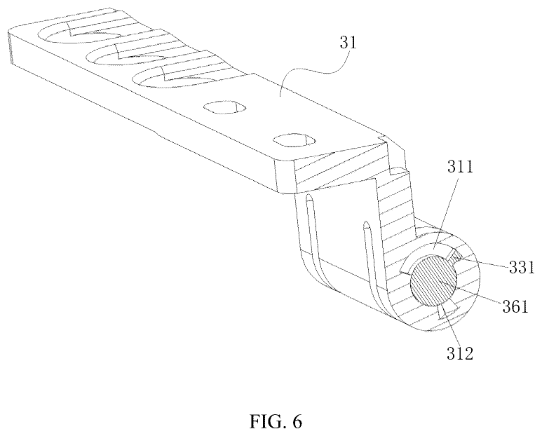

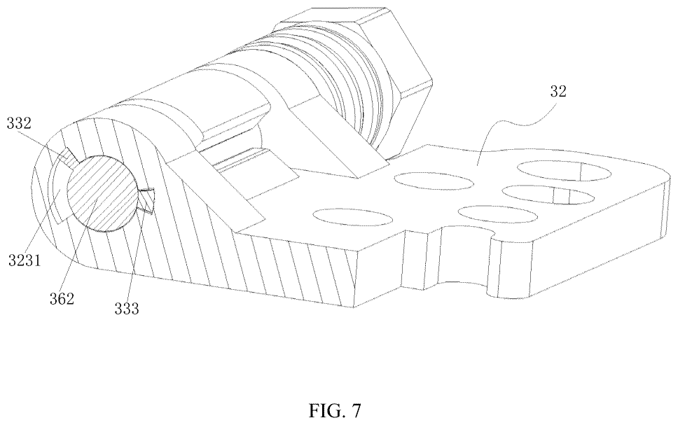

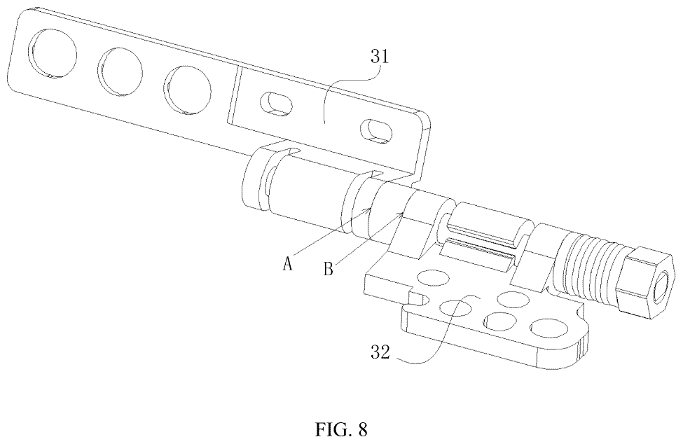

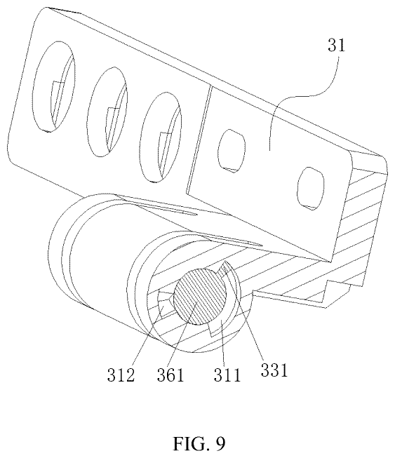

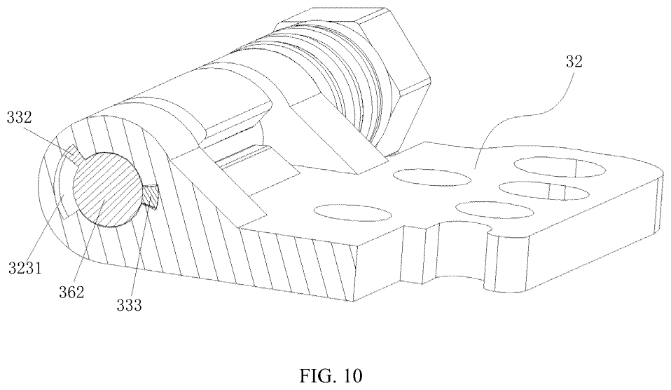

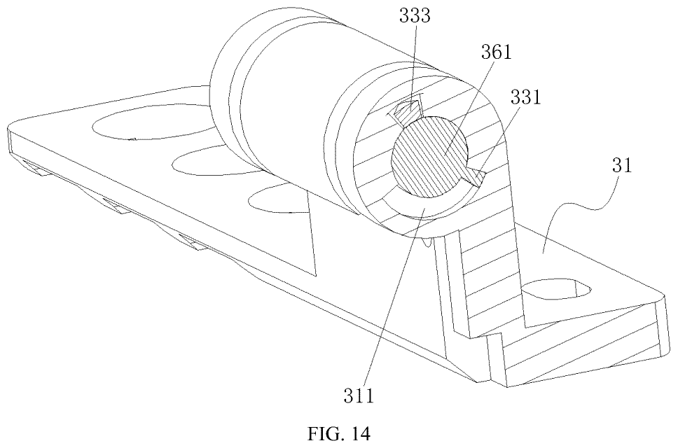

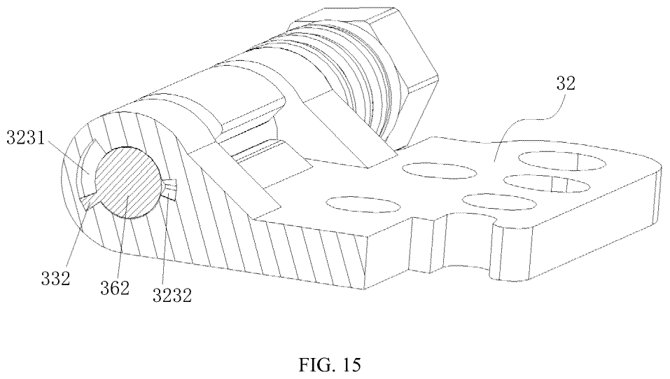

As shown in FIG. 1 to FIG. 26, one embodiment of the present disclosure provides a connection device 3. The connection device 3 includes a shaft 36, a first motion assembly 31 and a second motion assembly 32. The first motion assembly 31 is connected to the shaft 36 and used to connect a first body 1, and the second motion assembly 32 is connected to the shaft 36 and used to connect a second body 2. When the connection device 3 is in a first angle range, the second motion assembly 32 is in a first state where the position relative to the shaft 36 remains unchanged, and the first motion assembly 31 is in a second state. When the connection device 3 is in a second angle range, the first motion assembly 31 is in a first state where the position relative to the shaft 36 remains unchanged, and the second motion assembly 32 is in a second state.

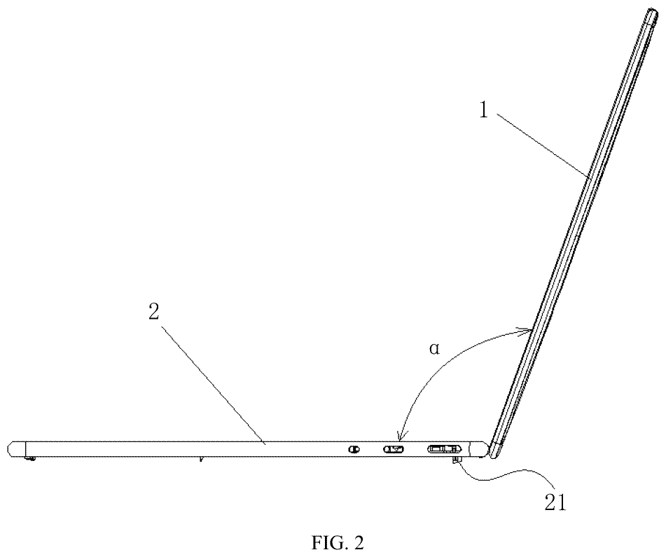

The first body 1 and the second body 2 are objects connected by the connection device 3, and they are able to rotate relative to each other with the assistance of the connection device 3, to achieve opening and closing. For example, in one embodiment, the first body 1 and the second body 2 may be a screen part and a main unit part of a laptop computer, respectively, as shown in FIG. 1. In another embodiment, the first body 1 and the second body 2 may be a first part and a second part on two sides of a bend part of a foldable tablet computer or a mobile phone, respectively. The present disclosure does not limit the objects connected by the connection device 3. As shown in FIG. 2, when the first body 1 and the second body 2 are being opened or closed relative to each other, angle α between the first body 1 and the second body 2 changes. Since the first motion assembly 31 of the connection device 3 is connected to the first body 1 and the second motion assembly 32 is connected to the second body 2, the connection device 3 may be able to change its angle corresponding to angle α. The angle change of the connection device 3 may cover two adjacent angle ranges, that is, a first angle range and a second angle range. For one same motion assembly, i.e., either the first motion assembly 31 or the second motion assembly 32, when the connection device 3 is in different angle ranges, the states of the motion assembly may be different. For different motion assemblies, i.e., the first motion assembly 31 and the second motion assembly 32, when the connection device 3 is in any of the above two angle ranges, i.e., either the first angle range or the second angle range, the states of the first motion assembly 31 and the second motion assembly 32 may be different. The states of one motion assembly may include a first state and a second state. The first state and the second state differ from each other in that the first state refers to a state in which the position of the motion assembly relative to the shaft 36 remains unchanged, and the second state refers to a state in which the position of the motion assembly relative to the shaft 36 is variable. That is, when in the first state, the motion assembly cannot move relative to the shaft 36; and, when in the second state, the motion assembly can move relative to the shaft 36.

The first motion assembly 31 and the second motion assembly 32 may both be connected to the shaft 36 of the connection device 3. The first motion assembly 31 and the second motion assembly 32 may be respectively used to connect the first body 1 and the second body 2, that is, the first motion assembly 31 may be provided with a first connector fixedly connected to the first body 1, the second motion assembly 32 may be provided with a second connector 321 fixedly connected to the second body 2, and the shaft 36 may not be provided with a connector fixedly connected to the first body 1 or the second body 2. Since the second motion assembly 32 is in the first state where the position relative to the shaft 36 remains unchanged and the first motion assembly 31 is in the second state when the connection device 3 is in the first angle range, and the first motion assembly 31 is in the first state where the position relative to the shaft 36 remains unchanged and the second motion assembly 32 is in the second state when the connection device 3 is in the second angle range, in the present disclosure, the connection device 3 may make it easier for designers to set torques for different angle ranges where the connection device 3 is located. Therefore, in a scenario where the connection device 3 is applied to a laptop computer, compared with the structural design of the existing connection device, the connection device 3 of the present disclosure may be conducive to reducing the design difficulty of the one-handed opening function of the laptop computer. As shown in FIG. 2, the one-handed opening function of the laptop computer means that, when the laptop computer is placed on a horizontal desktop and angle α is 0°, the user lifts the first body 1 with one hand to open the first body 1 and the second body 2 to each other, and the second body 2 does not rise following the first body 1. If the second body 2 is lifted up together with the first body 1 when the laptop computer placed on the horizontal desktop is opened with one hand, it means that the laptop computer cannot be opened with one hand, that is, it does not have the one-handed opening function.

As shown in FIG. 2, in the process of opening the first body 1 and the second body 2, angle α gradually increases from 0°, first passes through the first angle range, and then passes through the second angle range to reach the maximum unfolding angle. In the process of closing the first body 1 and the second body 2, angle α gradually decreases from the maximum unfolding angle, first passes through the second angle range, and then passes through the first angle range to reach 0°. The above is a complete relative rotation process of the first body 1 and the second body 2 in the full stroke. Of course, when the user is using the laptop, a single opening or closing action may only correspond to a portion of the full stroke. For example, the user may gradually increase angle α from 0°, first pass through the first angle range, and then stop opening when reaching a certain angle in the second angle range, in a certain opening process. Or the user may gradually decrease angle α from a certain angle in the second angle range, and then stop closing when reaching a certain angle in the first angle range, in a certain closing process.

In some embodiments, the first angle range may be larger than the second angle range. In practical applications, the first angle range may generally correspond to the stage in which the user easily opens the first body 1. After this stage, it may usually continue to open a little bit, such that angle α enters the second angle range and then stops opening. To save the user as much effort as possible during the entire opening process, in the present disclosure, the first angle range may be set to be larger than the second angle range, to ensure that the user is able to complete the entire opening process more easily. For example, the maximum expansion angle of angle α may be 180°, the first angle range may be set to 0°˜110°, and the second angle range may be set to 110°˜180°. Of course, in other embodiments, the critical angle between the first angle range and the second angle range may also be set to other values larger than 90°, such as 100°, 120°, etc.

In one embodiment, the shaft 36 may include a first shaft member 361 and a second shaft member 362, and the axis of the first shaft member 361 and the axis of the second shaft member 362 may meet the parallel condition. The first motion assembly 31 may be connected to the first shaft member 361, and the second motion assembly 32 may be connected to the second shaft member 362. When the connection device 3 is in the first angle range, the first motion assembly 31 may rotate relative to the first shaft member 361; and, when the connection device 3 is in the second angle range, the second motion assembly 32 may rotate relative to the second shaft member 362. In some embodiments, the axis of the first shaft member 361 and the axis of the second shaft member 362 may coincide with each other, or may be staggered. That is, the first shaft member 361 and the second shaft member 362 may be coaxially arranged or eccentrically arranged, as long as the axis of the first shaft member 361 and the axis of the second shaft member 362 meet the parallel condition. In some embodiments, the first shaft member 361 and the second shaft member 362 may be coaxially arranged, such that the overall structure of the connection device 3 is more compact, which is conducive to the application of the connection device 3 in electronic devices with a smaller thickness.

When the connection device 3 is in the first angle range, the first motion assembly 31 may be in the second state and may be able to rotate relative to the first shaft member 361, and the second motion assembly 32 may be in the first state with a constant position relative to the shaft 36, such that the first body 1 and the second body 2 achieve relative rotation through the first motion assembly 31 when the connection device 3 is in the first angle range. When the connection device 3 is in the second angle range, the first motion assembly 31 may be in the first state with a constant position relative to the shaft 36, and the second motion assembly 32 may be in the second state and may be able to rotate relative to the second shaft member 362, such that the first body 1 and the second body 2 achieve relative rotation through the second motion assembly 32 when the connection device 3 is in the second angle range.

In some embodiments, the shaft 36 may include a switch assembly 33, and the switch assembly 33 may be located between the first shaft member 361 and the second shaft member 362. The switch assembly 33 may be used to switch the connection device 3 from the first angle range to the second angle range, such that the first motion assembly 31 is switched from the second state to the first state, and the second motion assembly 32 is switched from the first state to the second state. The switch assembly 33 may be used to switch the connection device 3 from the second angle range to the first angle range, such that the first motion assembly 31 is switched from the first state to the second state, and the second motion assembly 32 is switched from the second state to the first state. Setting the switch assembly 33 between the first shaft member 361 and the second shaft member 362 may be conducive to simplifying the overall structure of the connection device 3.

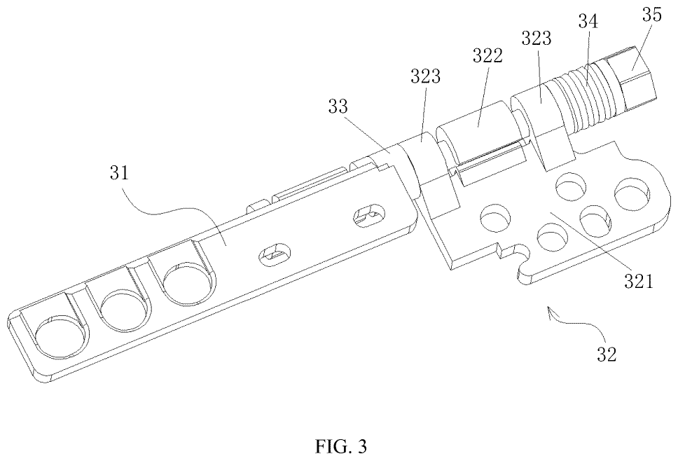

As shown in FIG. 3 to FIG. 19, in one embodiment, the switch assembly 33 includes a switch member 333, and the switch member 333 is able to move parallel to the axial direction of the shaft 36, such that the first motion assembly 31 or the second motion assembly 32 is in the first state in which the position relative to the shaft 36 remains unchanged. Exemplarily, in one embodiment, the critical angle between the first angle range and the second angle range may be set to 110°, the first angle range may be set to 0°˜110°, and the second angle range may be set to 110°˜180°. The switch assembly 33 may be provided with an axial slide slot extending parallel to the axial direction of the shaft 36, and the switch member 333 may be slidably matched with the axial slide slot. The switch member 333 may include a first end and a second end opposite to each other, and a first clamp slot 312 for accommodating the first end of the switch member 333 may be disposed on one side of the first motion assembly 31 close to the second motion assembly 32, and a second clamp slot 3232 for accommodating the second end of the switch member 333 may be disposed on one side of the second motion assembly 32 close to the first motion assembly 31. The switch assembly 33 may also be provided with a first protrusion 331 and a second protrusion 332. The first motion assembly 31 may be provided with a first slide slot 311 extending circumferentially along the shaft 36. The first protrusion 331 may be slidably matched with the first slide slot 311, and the sliding stroke of the first protrusion 331 in the first slide slot 311 may correspond to the size of the first angle range. The second motion assembly 32 may be provided with a second slide slot 3231 extending circumferentially along the shaft 36. The second protrusion 332 may be slidably matched with the second slide slot 3231, and the sliding stroke of the second protrusion 332 in the second slide slot 3231 may correspond to the size of the second angle range.

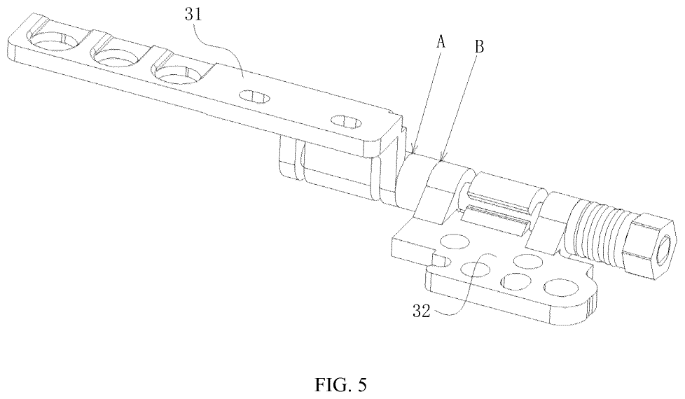

As shown in FIG. 2, and FIG. 5 to FIG. 10, when angle α is 0°, the first protrusion 331 is located at the first end of the first slide slot 311, the second protrusion 332 is located at the first end of the second slide slot 3231, the first end of the switch member 333 is not stuck in the first slot 312, and the second end of the switch member 333 is stuck in the second slot 3232. In the process of the first body 1 opening from angle α of 0° to angle α of 110°, the first motion assembly 31 rotates relative to the shaft 36, and the first protrusion 331 reaches the second end of the first slide slot 311 from the first end of the first slide slot 311. During this process, the switch member 333 does not move. Since the switch member 333 locks the second motion assembly 32 and the shaft 36 together, the hindering torque for opening the first body 1 comes from the action force between the first motion assembly 31 and the shaft 36.

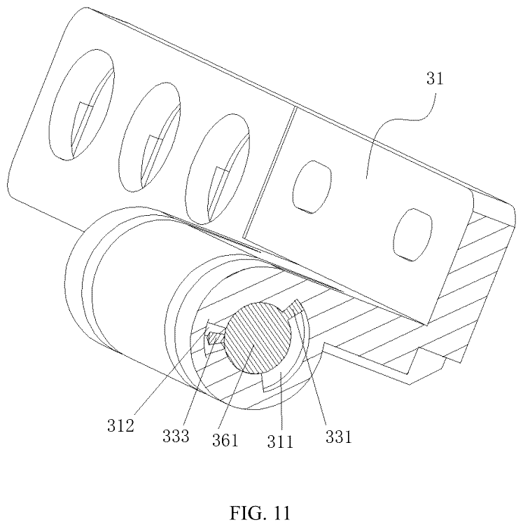

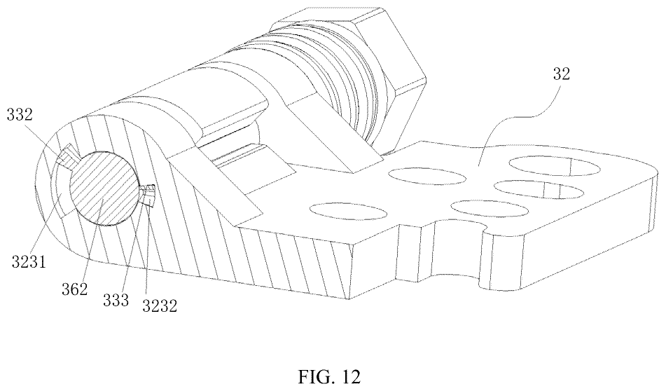

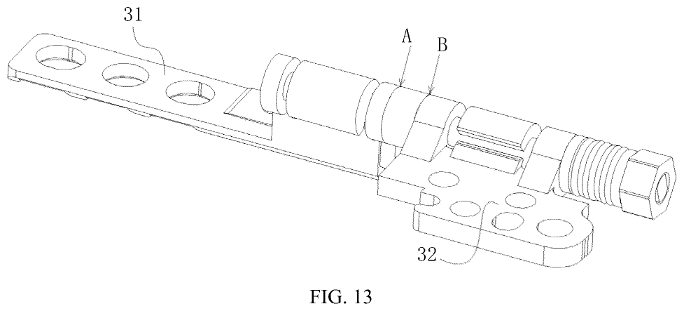

As shown in FIG. 11 and FIG. 12, when the first body 1 continues to open at angle α of 110°, since the second end of the first slide slot 311 is engaged with the first protrusion 331, the shaft 36 moves with the first motion assembly 31 relative to the second motion assembly 32, and at the same time forces the switch member 333 to move relative to the shaft 36, that is, the first end of the switch member 333 gradually enters the first clamp slot 312, and the second end of the switch member 333 gradually exits the second clamp slot 3232. In this process, the hindering torque for opening the first body 1 comes from the force between the second motion assembly 32 and the shaft 36. As shown in FIG. 13 to FIG. 15, when the first body 1 is opened to angle α of 180°, the second protrusion 332 reaches the second end of the second slide slot 3231 from the first end of the second slide slot 3231, and the second end of the switch member 333 completely withdraws from the second clamp slot 3232. The first end of the switch member 333 is engaged with the first clamp slot 312, locking the first motion assembly 31 and the shaft 36 together.

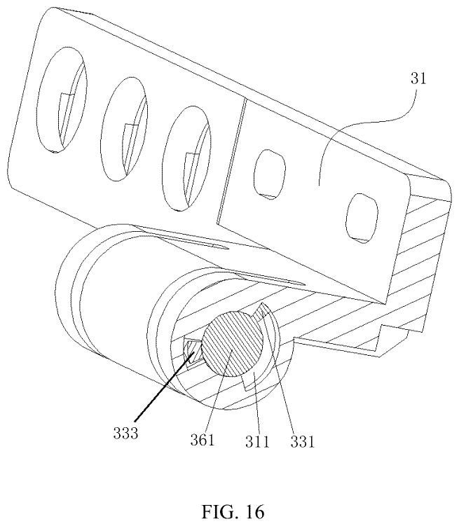

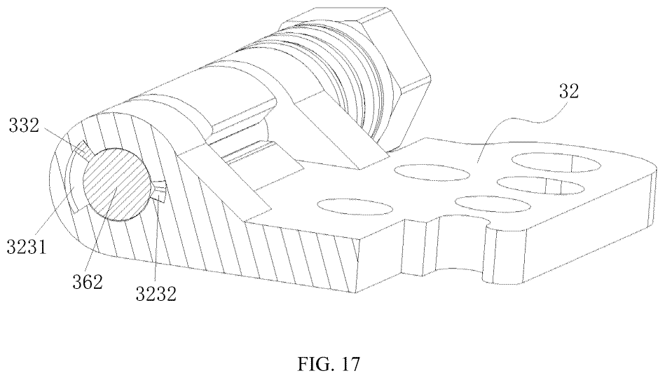

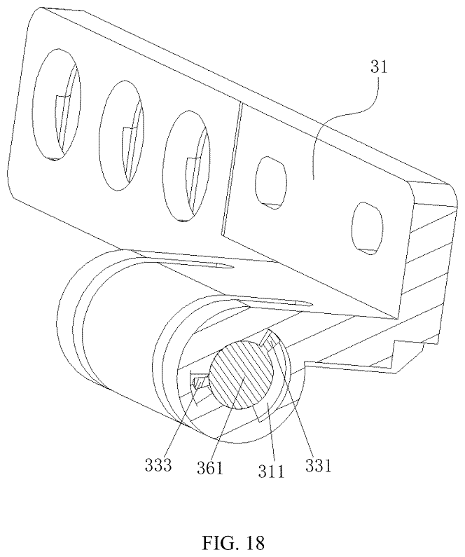

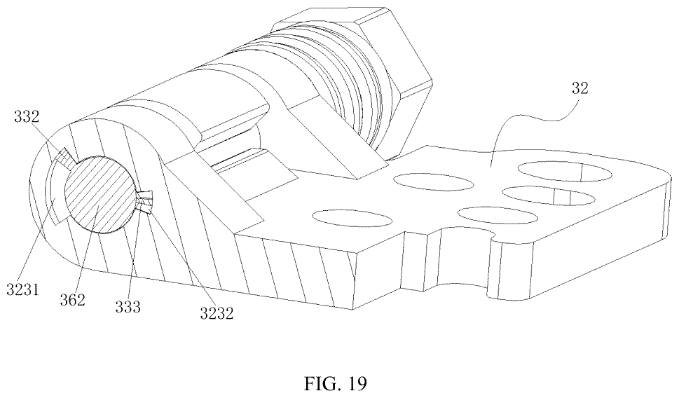

As shown in FIG. 16 and FIG. 17, during the process of the first body 1 closing from angle α of 180° to angle α of 110°, the second motion assembly 32 rotates relative to the shaft 36, and the second protrusion 332 reaches the first end of the second slide slot 3231 from the second end of the second slide slot 3231. During this process, the switch member 333 does not move. Since the switch member 333 locks the first motion assembly 31 and the shaft 36 together, the hindering torque for closing the first body 1 comes from the action force between the second motion assembly 32 and the shaft 36. As shown in FIG. 18 and FIG. 19, when the first body 1 continues to close on the basis of angle α being 110°, since the second end of the second slide slot 3231 is engaged with the second protrusion 332 to limit the relative rotation of the shaft 36 and the second motion assembly 32, the shaft 36 and the second motion assembly 32 move together relative to the first motion assembly 31, and at the same time force the switch member 333 to move relative to the shaft 36, that is, the second end of the switch member 333 gradually enters the second clamp slot 3232, and the first end of the switch member 333 gradually exits the first clamp slot 312. In this process, the hindering torque for closing the first body 1 comes from the force between the first motion assembly 31 and the shaft 36. When the first body 1 is closed to angle α of 0°, the connection device 3 returns to the structure shown in FIG. 5 to FIG. 7.

In some embodiments, the first motion assembly 31 may include a first shaft sleeve assembly connected to the shaft 36, and the second motion assembly 32 may include a second shaft sleeve assembly connected to the shaft 36. When the connection device 3 is in the first angle range, the first shaft sleeve assembly may have a first friction force when moving from the first relative position to the second relative position relative to the shaft 36, and the first shaft sleeve assembly may have a second friction force when moving from the second relative position to the first relative position relative to the shaft 36. The second friction force may be larger than the first friction force. When the connection device 3 is in the second angle range, the second shaft sleeve assembly may have a third friction force when moving from the third relative position to the fourth relative position relative to the shaft 36, and the second shaft sleeve assembly may have a third friction force when moving from the fourth relative position to the third relative position relative to the shaft 36. The fourth friction force may be smaller than the third friction force. That is, when the connection device 3 is in the first angle range, the first shaft sleeve assembly may rotate relative to the shaft 36, and the friction between the first shaft sleeve assembly and the shaft 36 may change with the rotation direction. When the connection device 3 is in the second angle range, the second shaft sleeve assembly may rotate relative to the shaft 36, and the friction between the second shaft sleeve assembly and the shaft 36 may change with the rotation direction. Exemplarily, when the connection device 3 of the present disclosure is applied to a laptop computer, the first shaft sleeve assembly may change from the first relative position to the second relative position relative to the shaft 36, corresponding to angle α in FIG. 2 changing from 0° to the critical angle of the first angle range and the second angle range (for example, 110°), and the second shaft sleeve assembly may change from the third relative position to the fourth relative position relative to the shaft 36, corresponding to angle α in FIG. 2 changing from the above critical angle to the maximum expansion angle of the first body 1 and the second body 2 (for example, 180°). It is easy to understand that the first friction force is the resistance of the first body 1 when it is opening within the first angle range, and the second friction force is the resistance of the first body 1 when it is closing within the first angle range. Since the second friction force is larger than the first friction force, the connection device 3 may achieves the effect of light opening and heavy closing within the first angle range through the first shaft sleeve assembly, that is, it may be easier and more relaxed for the user to open the first body 1 within the first angle range than to close it. The third friction force may be the resistance of the first body 1 when it is opening within the second angle range, and the fourth friction force may be the resistance of the first body 1 when it is closing within the second angle range. Since the fourth friction force is less than the third friction force, the connection device 3 may achieve the effect of heavy opening and light closing within the second angle range through the second sleeve part, that is, it may be more laborious for the user to open the first body 1 within the second angle range than to close it.

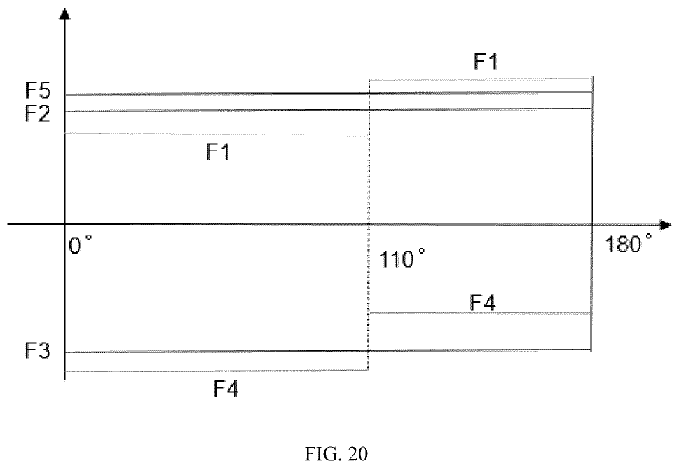

As shown in FIG. 20, when designing the one-handed opening function of a laptop computer through the connection device 3 provided by the present disclosure, torque may be set for different angle ranges where the connection device 3 is located respectively. The horizontal axis in FIG. 20 is the value of angle α. The increase of angle α corresponds to the opening action of the laptop computer, and the decrease of angle α corresponds to the closing action of the laptop computer. F1 is the shaft torque that needs to be overcome for the opening action, and F4 is the shaft torque that needs to be overcome for the closing action. It should be noted that the magnitude of the torque is reflected by the absolute value of the corresponding value on the vertical axis. F1 and F4 are located above and below the horizontal axis, respectively, only for the convenience of distinguishing the opening process and the closing process of the laptop computer. In the first angle range, that is, in the interval of 0°˜110° of the horizontal axis, F1 is generated by the above-mentioned first friction force, and F4 is generated by the above-mentioned second friction force. In the second angle range, that is, in the interval of 110°˜180° of the horizontal axis, F1 is generated by the above-mentioned third friction force, and F4 is generated by the above-mentioned fourth friction force.

F2 is the torque generated by the weight of the main unit part of the laptop computer, i.e., the second body 2. In the range of 0°˜110° of the horizontal axis, F1 is smaller than F2, such that the second body 2 is not lifted up when the first body 1 is opened and the laptop is able to be opened with one hand. F3 is the torque generated by the weight of the screen part of the laptop computer, i.e., the first body 1. In the range of 110°˜180° of the horizontal axis, F4 is smaller than F3, such that the user can close the first body 1 more easily. In the range of 0°˜110° of the horizontal axis, F4 is larger than F3, which ensures that the first body 1 will not fall freely before angle α decreases to a specified small angle (such as 20°). F5 is the torque generated by the user's touch operation force on the first body 1 when the screen part of the laptop computer includes a touch screen. In the range of 110°˜180° of the horizontal axis, F1 is larger than F5, and F5 is larger than F2, which ensures that the shaft torque is able to support the user's touch operation force, that is, ensures that the first body 1 remains stationary during the user's touch operation. At the same time, it may also be ensured that the first body 1 will not fall freely before angle α increases to a predetermined large angle (such as 160°).

It should be understood that F2 is the torque generated by the weight of the main body of the notebook computer and centered on the support point close to the connection device 3 (such as the foot pad 21 in FIG. 2), and F3 is the torque generated by the weight of the screen part of the notebook computer and centered on the axis of the shaft 36.

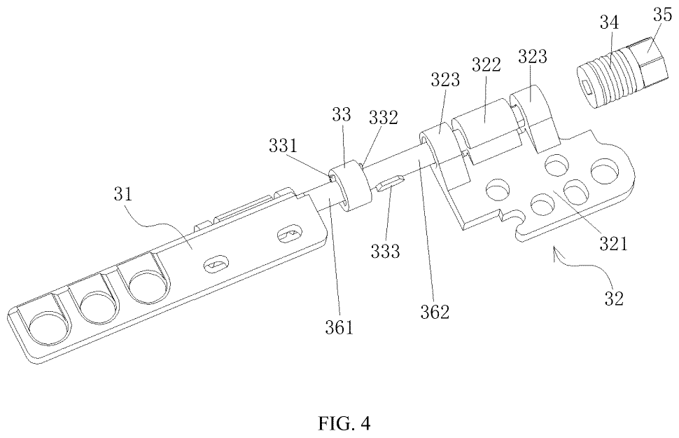

As shown in FIG. 3 and FIG. 4, in some embodiments, the first shaft sleeve assembly has a first sleeve member and a second sleeve member. The first sleeve member is used to generate a friction force that varies with the rotation direction relative to the shaft 36, and the second sleeve member is used to position relative to the shaft 36. Similarly, the second shaft sleeve assembly has a third sleeve member 322 and a fourth sleeve member 323. The third sleeve member 322 is used to generate a friction force that varies with the rotation direction relative to the shaft 36, and the fourth sleeve member 323 is used to position relative to the shaft 36. For example, taking the third sleeve member 322 as an example, to generate the friction force that varies with the rotation direction relative to the shaft 36, in one embodiment, the second shaft sleeve assembly may include a C-shaped third sleeve member 322 that is covered on the second shaft member 362. One end of the third sleeve member 322 may be fixedly connected to the second connector 321, and the other end may extend along the circumference of the second shaft member 362 to form a wrap. As shown in FIG. 4 and FIG. 5, the C-shaped third sleeve member 322 does not completely wrap the second shaft member 362, but has an opening. Because of the existence of the opening, a portion of the third sleeve member 322 away from the second connector 321 becomes a free end that is able to be slightly driven by the rotating second shaft member 362. As the second shaft member 362 rotates in different directions relative to the third sleeve member 322, the free end of the third sleeve member 322 wraps around the second shaft member 362 with different degrees of tightness, such that the friction force between the third sleeve member 322 and the second shaft member 362 is different, that is, the third sleeve member 322 is able to generate friction relative to the shaft 36 that changes with the rotation direction.

In some embodiments, at least one of the first shaft member 361 and the second shaft member 362 may be provided with an elastic member 34 and a nut 35 at the end away from the other, such that at least one of the first shaft sleeve assembly and the second shaft sleeve assembly is axially opposed to the corresponding elastic member 34 at the end away from the other. In one embodiment, the elastic member 34 may be a coil spring or a disc spring assembly.

The switch assembly 33 may be formed by a third shaft member located between the first shaft member 361 and the second shaft member 362, as shown in FIG. 3 and FIG. 4. The diameter of the third shaft member may be larger than the diameter of the first shaft member 361 to form a first shaft shoulder member that rests against the first shaft sleeve assembly, and the diameter of the third shaft member may be larger than the diameter of the second shaft member 362 to form a second shaft shoulder member that rests against the second shaft sleeve assembly. The axial slide slot may pass through the third shaft member axially.

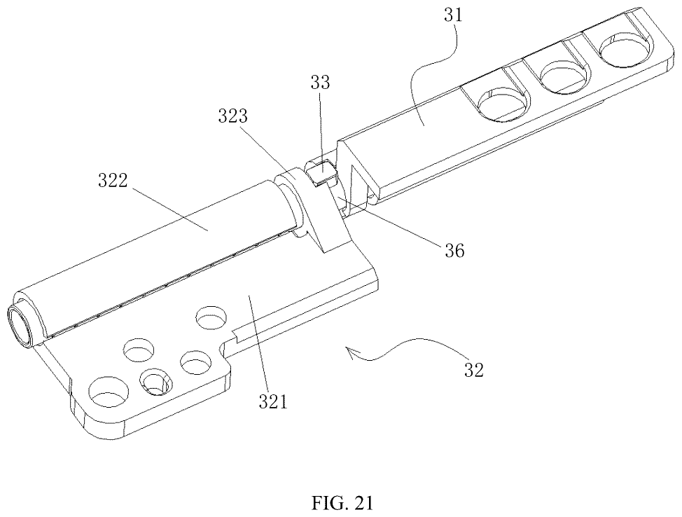

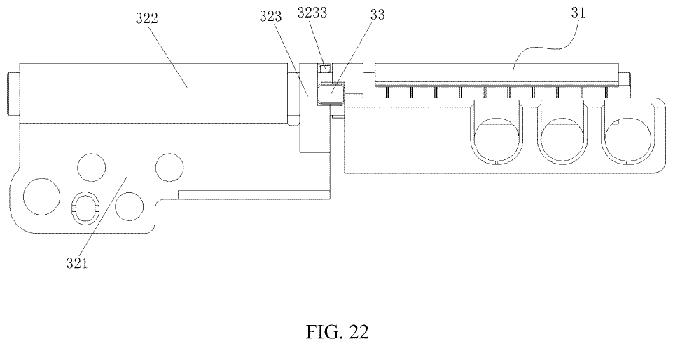

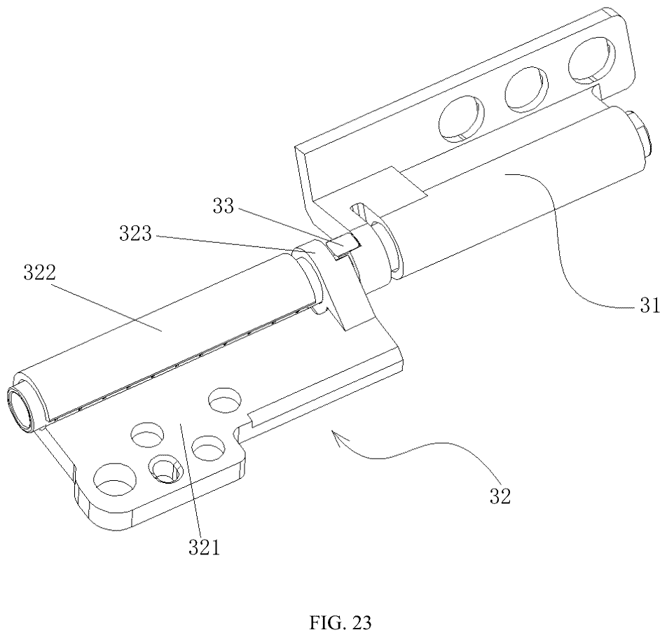

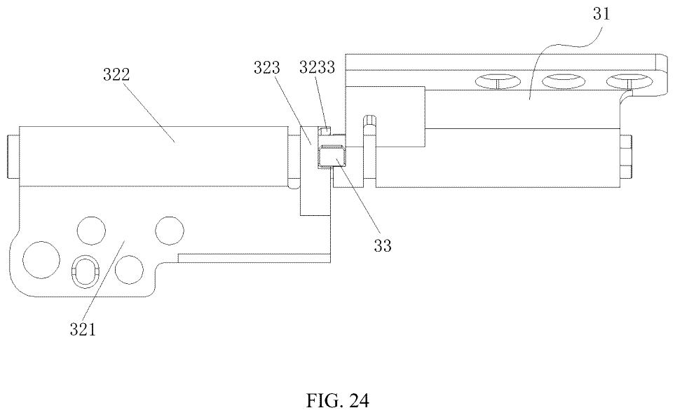

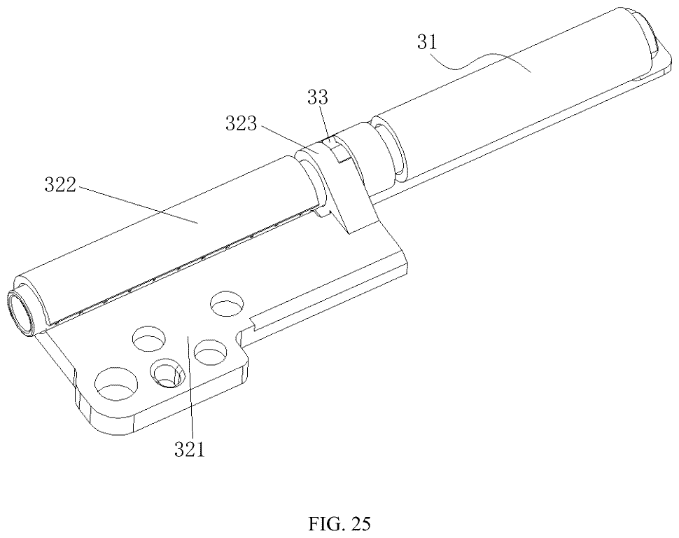

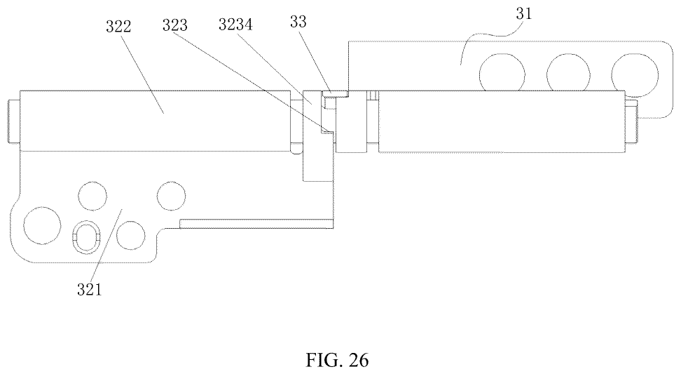

In some other embodiments, the switch assembly 33 may not be provided with the switch member 333. As shown in FIG. 21 to FIG. 26, in one embodiment, the switch assembly 33 includes a first switch part for cooperating with the first motion assembly 31 and a second switch part for cooperating with the second motion assembly 32. The first switch part may be used to switch the first motion assembly 31 from the second state to the first state, and the second switch part may be used to switch the second motion assembly from the second state to the first state. The first shaft sleeve assembly may include a first sleeve member and a second sleeve member. The first sleeve member may be used to generate a friction force that changes with the rotation direction relative to the shaft 36, and the second sleeve member may be used to position relative to the shaft 36. The second sleeve member may be provided with a first stopper (not marked in the figure) and a second stopper (not marked in the figure) that cooperate with the first switch part of the switch assembly 33. Similarly, the second shaft sleeve assembly may include a third sleeve member 322 and a fourth sleeve member 323. The third sleeve member 322 may be used to generate a friction force that changes with the rotation direction relative to the shaft 36. The fourth sleeve member 323 may be used to position relative to the shaft 36. The fourth sleeve member 323 may be provided with a third stopper 3233 and a fourth stopper 3234 that cooperate with the second switch part of the switch assembly 33. When angle α is 0°, as shown in FIG. 21 and FIG. 22, the first switch part of the switch assembly 33 contacts the first stopper, and the second switch part of the switch assembly 33 contacts the fourth stopper 3234. In the process of opening the first body 1 to increase angle α from 0° to 110°, since the friction force between the first shaft sleeve assembly and the shaft 36 is less than the friction force between the second shaft sleeve assembly and the shaft 36, the second motion assembly 32 is in the first state where the position relative to the shaft 36 remains unchanged. When the first body 1 is opened to angle α of 110°, as shown in FIG. 23 and FIG. 24, the first switch part of the switch assembly 33 contacts the second stopper, such that the shaft 36 moves with the first motion assembly 31 when the first body 1 continues to open from angle α of 110°, that is, the first motion assembly 31 is in the first state where the position relative to the shaft 36 remains unchanged. When the first body 1 is opened to angle α of 180°, as shown in FIG. 25 and FIG. 26, the second switch part of the switch assembly 33 contacts the third stopper 3233.

The first sleeve member of the first shaft sleeve assembly may be used to generate a friction force that changes with the rotation direction relative to the shaft 36, and the second sleeve member of the second shaft sleeve assembly may be used to generate a friction force that changes with the rotation direction relative to the shaft 36. Therefore, when the first body 1 is closed, the friction force between the first shaft sleeve assembly and the shaft 36 and the friction force between the second shaft sleeve assembly and the shaft 36 may change compared with the opening process of the first body 1. In the process of closing the first body 1 to reduce angle α from 180° to 110°, since the friction force between the first shaft sleeve assembly and the shaft 36 may be larger than the friction force between the second shaft sleeve assembly and the shaft 36, the first motion assembly 31 may be in the first state where the position relative to the shaft 36 remains unchanged, and the shaft 36 may move with the first motion assembly 31. When the first body 1 is closed to angle α of 110°, as shown in FIG. 23 and FIG. 24, the second switch part of the switch assembly 33 contacts the fourth stopper 3234. Therefore, when the first body 1 continues to be closed from angle α of 110°, the second motion assembly 32 may be in the first state where the position relative to the shaft 36 remains unchanged. When the first body 1 is closed to angle α of 0°, as shown in FIG. 21 and FIG. 22, the first switch part of the switch assembly 33 contacts the first stopper.

The present disclosure also provides an electronic device, including a first body 1, a second body 2 and a connection device 3. The connection device 3 may be used for the first body 1 to rotate relative to the second body 2. The connection device 3 may include a shaft 36, a first motion assembly 31 and a second motion assembly 32. The first motion assembly 31 may be connected to the shaft 36, and the first motion assembly 31 may be connected to the first body 1. The second motion assembly 32 may be connected to the shaft 36, and the second motion assembly 32 may be connected to the second body 2. When the electronic device is in a first usage mode, the connection device 3 may be in a first angle range, the second motion assembly 32 may be in a first state in which the position relative to the shaft 36 remains unchanged, and the first motion assembly 31 may be in a second state. When the electronic device is in a second usage mode, the connection device 3 may be in a second angle range, the first motion assembly 31 may be in a first state in which the position relative to the shaft 36 remains unchanged, and the second motion assembly 32 may be in a second state. For example, the electronic device may be a laptop computer, a foldable tablet computer or other types. As shown in FIG. 20, the first usage mode of the electronic device corresponds to angle α between the first body 1 and the second body 2 being in a first angle range, such as a range of 0° to 110°. The second usage mode of the electronic device corresponds to angle α between the first body 1 and the second body 2 being in the second angle range, for example, in the range of 110° to 180°. Taking a laptop computer as an example, in the first usage mode, the shaft torque when the screen part, i.e., the first body 1, is opened, may be F1 in the range of 0° to 110°, and the shaft torque when the first body 1 is closed may be F4 in the range of 0° to 110°. In the second usage mode, the shaft torque when the screen part, i.e., the first body 1, is opened, may be F1 in the range of 110° to 180°, and the shaft torque when the first body 1 is closed may be F4 in the range of 110° to 180°.

The first body 1 may have a first force, and the first force may be related to the weight of the first body 1, corresponding to F3 in FIG. 20. The second body 2 may have a second force, and the second force may be related to the weight of the second body 2, corresponding to F2 in FIG. 20. In some embodiments, when the electronic device is in the first usage mode, the first motion assembly 31 may have a first friction force when moving from the first relative position to the second relative position relative to the shaft 36, and the first motion assembly 31 may have a second friction force when moving from the second relative position to the first relative position relative to the shaft 36. The second friction force may be larger than the first friction force, the first friction force may be less than the second force, and the second friction force may be larger than the first force. The first friction force corresponds to F1 in the range of 0°˜110° in FIG. 20, and the second friction force corresponds to F4 in the range of 0°˜110° in FIG. 20. The second friction force may be larger than the first friction force to achieve light opening/heavy closing effect in the first usage mode. The first friction force may be less than the second force to ensure that the electronic device has a one-handed opening function, and the second friction force may be larger than the first force to ensure that the first body 1 does not fall freely when angle α is larger than a specified small angle (such as) 20°.

When the electronic device is in the second usage mode, the second motion assembly 32 may have a third friction force when moving from the third relative position to the fourth relative position relative to the shaft 36, and the second motion assembly 32 may have a fourth friction force when moving from the fourth relative position to the third relative position relative to the shaft 36. The fourth friction force may be less than the third friction force, the third friction force may be larger than the second force, and the fourth friction force may be less than the first force. The third friction force corresponds to F1 in the range of 110°˜180° in FIG. 20, and the fourth friction force corresponds to F4 in the range of 110°˜180° in FIG. 20. The fourth friction force may be less than the third friction force to achieve the heavy opening and light closing effect in the second usage mode. The fourth friction force may be less than the first force to ensure that the electronic device may be easy to close, and the third friction force may be larger than the second force to ensure that the first body 1 does not fall freely when angle α may be larger than a specified large angle (such as 160°).

In some embodiments, the first body 1 may be a display surface with a touch function. When the electronic device is in the second usage mode, the first body 1 may have a third force, and the third force may be larger than the second force, and the third force may be less than the third friction force. The third force may be related to the user's touch operation force, corresponding to F5 in FIG. 20. The third force may be less than the third friction force to ensure that the first body 1 remains stationary during the user's touch operation.

In the present disclosure, the structures of each part may be described in a progressive manner, and the structure of each part focuses on the differences from the existing structure. The overall and partial structures of the connection device 3 and the electronic device may be obtained by combining the structures of the above multiple parts.

Various embodiments have been described to illustrate the operation principles and exemplary implementations. Those skilled in the art would understand that the present disclosure is not limited to the specific embodiments described herein and there can be various other changes, rearrangements, and substitutions. Thus, while the present disclosure has been described in detail with reference to the above described embodiments, the present disclosure is not limited to the above described embodiments, but may be embodied in other equivalent forms without departing from the spirit and scope of the present disclosure.

What is claimed is:

1. A connection device comprising:
a shaft;
a first motion assembly connected to the shaft; and
a second motion assembly connected to the shaft;
wherein:
when the connection device is in a first angle range, the second motion assembly is in a first state in which a position of the second motion assembly relative to the shaft remains unchanged, and the first motion assembly is in a second state; and
when the connection device is in a second angle range, the first motion assembly is in the first state in which a position of the first motion assembly relative to the shaft remains unchanged, and the second motion assembly is in the second state.

2. The connection device according to claim 1, wherein the first angle range is larger than the second angle range.

3. The connection device according to claim 1, wherein:
the shaft includes a first shaft member and a second shaft member, an axis of the first shaft member and an axis of the second shaft member meeting a parallel condition;
the first motion assembly is connected to the first shaft member, and the second motion assembly is connected to the second shaft member;
when the connection device is in the first angle range, the first motion assembly is able to rotate relative to the first shaft member; and
when the connection device is in the second angle range, the second motion assembly is able to rotate relative to the second shaft member.

4. The connection device according to claim 3, wherein:
the shaft includes a switch assembly located between the first shaft member and the second shaft member; and
the switch assembly is configured to:
switch the first motion assembly from the second state to the first state and switch the second motion assembly from the first state to the second state, when the connection device switches from the first angle range to the second angle range; and
switching the first motion assembly from the first state to the second state and switch the second motion assembly from the second state to the first state, when the connection device switches from the second angle range to the first angle range.

5. The connection device according to claim 4, wherein the switch assembly includes a switch member configured to move parallel to an axial direction of the shaft, to keep the first motion assembly or the second motion assembly in the first state.

6. The connection device according to claim 4, wherein the switch assembly includes:
a first switch part configured to cooperate with the first motion assembly to switch the first motion assembly from the second state to the first state; and
a second switch part configured to cooperate with the second motion assembly to switch the second motion assembly from the second state to the first state.

7. The connection device according to claim 1, wherein:
the first motion assembly includes a first shaft sleeve assembly connected to the shaft and configured to, when the connection device is in the first angle range:
have a first friction force when moving from a first relative position to a second relative position relative to the shaft, and
having a second friction force when moving from the second relative position to the first relative position relative to the shaft, the second friction force being larger than the first friction force; and
the second motion assembly includes a second shaft sleeve assembly connected to the shaft and configured to, when the connection device is in the second angle range:
have a third friction force when moving from a third relative position to a fourth relative position relative to the shaft, and
have a third friction force when moving from the fourth relative position to the third relative position relative to the shaft, the fourth friction force being less than the third friction force.

8. An electronic device comprising:
a first body;
a second body; and
a connection device including:
a shaft;
a first motion assembly connected to the shaft and the first body; and
a second motion assembly connected to the shaft and the second body;
wherein:
when the electronic device is in a first usage mode, the connection device is in a first angle range, the second motion assembly is in a first state in which a position of the second motion assembly relative to the shaft remains unchanged, and the first motion assembly is in a second state; and
when the electronic device is in a second usage mode, the connection device is in a second angle range, the first motion assembly is in the first state in which a position of the first motion assembly relative to the shaft remains unchanged, and the second motion assembly is in the second state.

9. The electronic device according to claim 8, wherein:
the first body has a first force, and the second body has a second force;
when the electronic device is in the first usage mode, the first motion assembly has a first friction force when moving from a first relative position to a second relative position relative to the shaft and has a second friction force when moving from the second relative position to the first relative position relative to the shaft, the second friction force being larger than the first friction force, the first friction force being less than the second force, and the second friction force being larger than the first force; and
when the electronic device is in the second usage mode, the second motion assembly has a third friction force when moving from a third relative position to a fourth relative position relative to the shaft and has a fourth friction force when moving from the fourth relative position to the third relative position relative to the shaft, the fourth friction force being less than the third friction force, the third friction force being larger than the second force, and the fourth friction force being less than the first force.

10. The electronic device according to claim 9, wherein:
the first body includes a display surface with a touch function; and
when the electronic device is in the second usage mode, the first body has a third force larger than the second force and less than the third friction force.

11. The electronic device according to claim 8, wherein the first angle range is larger than the second angle range.

12. The electronic device according to claim 8, wherein:
the shaft includes a first shaft member and a second shaft member, an axis of the first shaft member and an axis of the second shaft member meeting a parallel condition;
the first motion assembly is connected to the first shaft member, and the second motion assembly is connected to the second shaft member;
when the connection device is in the first angle range, the first motion assembly is able to rotate relative to the first shaft member; and
when the connection device is in the second angle range, the second motion assembly is able to rotate relative to the second shaft member.

13. The electronic device according to claim 12, wherein:
the shaft includes a switch assembly located between the first shaft member and the second shaft member; and
the switch assembly is configured to:
switch the first motion assembly from the second state to the first state and switch the second motion assembly from the first state to the second state, when the connection device switches from the first angle range to the second angle range; and
switching the first motion assembly from the first state to the second state and switch the second motion assembly from the second state to the first state, when the connection device switches from the second angle range to the first angle range.

14. The electronic device according to claim 13, wherein the switch assembly includes a switch member configured to move parallel to an axial direction of the shaft, to keep the first motion assembly or the second motion assembly in the first state.

15. The electronic device according to claim 13, wherein the switch assembly includes:
a first switch part configured to cooperate with the first motion assembly to switch the first motion assembly from the second state to the first state; and
a second switch part configured to cooperate with the second motion assembly to switch the second motion assembly from the second state to the first state.

16. The electronic device according to claim 8, wherein:
the first motion assembly includes a first shaft sleeve assembly connected to the shaft and configured to, when the connection device is in the first angle range:
have a first friction force when moving from a first relative position to a second relative position relative to the shaft, and
having a second friction force when moving from the second relative position to the first relative position relative to the shaft, the second friction force being larger than the first friction force; and
the second motion assembly includes a second shaft sleeve assembly connected to the shaft and configured to, when the connection device is in the second angle range:
have a third friction force when moving from a third relative position to a fourth relative position relative to the shaft, and
have a third friction force when moving from the fourth relative position to the third relative position relative to the shaft, the fourth friction force being less than the third friction force.
